(19) United States
(12) Patent Application Publication
(10) Pub. No.: US 2021/0180586 A1
(43) Pub. Date: Jun. 17, 2021

(54) System for Pumping a Compressible Liquid

(71) Applicant: Alexander Bozic, Oberursel (DE)

(72) Inventor: Alexander Bozic, Oberursel (DE)

(21) Appl. No.: 16/761,794

(22) PCT Filed: Nov. 5, 2018
(86) PCT No.: PCT/EP2018/080182

§ 371 Date: May 5, 2020

(30) Foreign Application Priority Data
Nov. 6, 2017 (DE) 10 2017 125 818.3

(51) Int. Cl. F04B 49/08; F04B 23/06; F04B 49/06

(52) U.S. Cl. CPC F04B 49/08; F04B 23/06; F04B 49/065; G01N 2030/326; F04B 2205/09; F04B 2205/13; F04B 2205/05

(57) ABSTRACT

A system for pumping a compressible fluid, a chromatography system comprising the system for pumping a compressible fluid, and a chromatography method using the system for pumping a compressible fluid, the system for pumping a compressible fluid comprising at least two pumps including a first pump and a second pump, respective pump outlet lines of which are brought together in a connection piece and are guided out of this connection piece into a common outlet line, wherein the second pump is controllable by a control unit, wherein the control unit is operatively connected to a flowmeter and the pump output of the second pump is controllable as a function of the flow measurement by the control unit.

The present invention relates to a system for pumping a compressible fluid, to a chromatography system and to a method for performing a chromatographic procedure.

Many advantages can be achieved through supercritical fluid chromatography (SFC), such that different substances can be particularly easily and reliably separated, chemically analyzed, identified and quantified. If carbon dioxide (CO₂) is used as a fluid in SFC applications, the extraction of the substances is generally carried out above the critical temperature of 31° C. and above a critical pressure of 74 bar.

To keep CO₂ or a CO₂ mixture in a liquid state within a chromatography column, the entire chromatography system must be kept at a predetermined pressure level. For this purpose, a backpressure regulator is typically provided downstream of the chromatography column and downstream of a respective detector, to keep the pressure within the chromatography system at a predetermined level.

Upstream of the chromatography column, a pump is typically used to pressurize the at least one solvent to a suitable pressure. In HPLC or SFC chromatography applications, the solvents, such as ethanol and/or CO₂, must be pressurized up to a level of several hundred bar, typically up to 400 bar, up to 1000 bar or even higher. In these pressure ranges, solvents such as CO₂ typically exhibit comparatively high compressibility.

This compressibility is, however, not constant but instead dependent on temperature and pressure, such that a simple conversion of conventional pump volumes is not an effective way of obtaining a predetermined proportion of liquid or supercritical CO₂ in a solvent mixture for a desired gradient.

The existence of this problem has long been known, although document WO 2015/121402 A1 does not, however, provide a solution for gradient chromatography in which the proportion of CO₂ is modified relative to at least one further solvent, but instead merely addresses the pulsation problem since the compressibility can give rise to an intensified pressure change which can in particular occur in a chromatographic procedure with a constant solvent mixture as is used in the separation of chiral compounds.

Patent application WO 2010/008851 A1 is a further document which addresses the above-described problem. Therein, it is described that the compressibility problem can be solved by a second upstream, series-connected pump. The system pump is in this case supplied with the liquid CO₂ at an appropriate pressure such that the upstream pump equalizes the compressibility and the system pump supplies a predetermined quantity of CO₂ to the chromatography column. This system works quite well, but the upstream series-connected pump must have a very high pump output which must correspond to the output of the system pump. At the outputs required for preparative chromatography, this system is thus very costly. Furthermore, any mismeasurement when determining the pressure can easily result in the upstream pump pumping through the system pump, meaning that too much liquid CO₂ is supplied to the chromatography column.

Considering the state of the art, it is therefore the object of the present invention to provide a system for pumping a compressible fluid which solves the aforementioned problems. The system for pumping a compressible fluid should be as simple and inexpensive to provide as possible. The system for pumping a compressible fluid should as reasonably priced as possible in relation to the volumetric flow rate at which the chromatography system is operated.

A further object of the present invention was to provide a system for pumping a compressible fluid which has low susceptibility to faults.

Accordingly, it was additionally an object of the present invention to provide a system for pumping a compressible fluid which has a simple structure and is easy to control. Furthermore, the system should exhibit the lowest possible susceptibility to faults, wherein faults should be particularly easy to identify and eliminate.

A further object is that of providing a system for pumping a compressible fluid which permits the simplest possible conversion of a known HPLC system into an SFC system, wherein existing pumps of the known HPLC system should preferably be included in the conversion.

These and further objects which are not explicitly mentioned, but can easily be derived or inferred from the correlations discussed in the introduction, are achieved by a system for pumping a compressible fluid which has all the features of claim 1.

The present invention accordingly relates to a system for pumping a compressible fluid, comprising at least two pumps, a first pump and a second pump, the respective pump outlet lines of which are brought together in a connection piece and are guided out of this connection piece into a common outlet line, which system is characterized in that the second pump is controllable by means of a control unit, wherein the control unit is operatively connected to a flowmeter and the pump output of the second pump is controllable as a function of the flow measurement by means of the control unit.

The present invention in particular ensures that a compressible fluid can also be reliably pumped in a predetermined volume under very different temperature and pressure conditions. In particular in comparison with other pump systems, an improvement is achieved to the effect that the predetermined objective can be achieved with a simple and inexpensive structure. Control over the pump system can also be improved.

Furthermore, the system for pumping a compressible fluid can be produced very inexpensively and simply. The system for pumping a compressible fluid moreover requires little maintenance and can be straightforwardly monitored.

A very good, in particular high, pump output can furthermore also reliably be achieved at different and rapidly changing volumetric flow rates. The system for pumping a compressible fluid can moreover be used for converting an existing HPLC system without its being necessary to replace the existing pumps.

Gradient chromatography can furthermore very reliably be carried out with the system for pumping a compressible fluid.

The present invention is based on the insight that a predetermined flow rate can be achieved by feeding a quantity of a compressible fluid which has been determined on the basis of a flow measurement. Consequently, it is in particular possible to reduce the complexity which was previously necessary and the reliability of the system can be improved, wherein in particular fault analysis is facilitated on the basis of the logging of the measured flow rates enabled by the present invention.

The system according to the invention enables pumping of a compressible fluid. A compressible fluid here in particular denotes a liquid or a fluid in the supercritical state which has high compressibility. High compressibility subsists if, at a pressure of 600 bar and a temperature of 20° C., the liquid or supercritical fluid has a relative compressibility (ΔV/V) of at least 5%, preferably at least 10%. Under these conditions, carbon dioxide (CO₂) exhibits relative compressibility (ΔV/V) of approximately 20%.

The system according to the invention for pumping a compressible fluid comprises at least two pumps, a first pump and a second pump. The nature of the pumps is immaterial for purposes of the present invention. Rotary piston pumps, centrifugal pumps, gear pumps and piston pumps can accordingly be used. The invention does, however, permit the use of inexpensive piston pumps which can preferably comprise at least two pistons. In piston pumps with at least two pistons, the two pistons can be controlled via a camshaft. The two pistons can furthermore be mutually independently controlled, wherein control via a camshaft is often less expensive and can be used for the purposes of the present invention. The first pump and/or the second pump is preferably formed as a piston pump, wherein the pump head is coolable.

It can furthermore be provided that the pump output of the first pump is higher than the pump output of the second pump, wherein the pump output of the first pump is preferably at least twice the pump output of the second pump, measured to DIN EN ISO 17769 (2012). The pump output of the second pump preferably amounts to at most 40%, particularly preferably at most 30% and especially preferably at most 20% of the pump output of the first pump. These differences in pump output in particular relate to the volumetric flow rates deliverable by the two pumps since the pressure to be provided should be substantially identical. It can thus be provided that the first pump can preferably deliver a volumetric flow rate in the range from 10 ml/min to 450 ml/min, particularly preferably in the range from 50 ml/min to 300 ml/min and especially preferably 100 ml/min to 250 ml/min, at a pressure of approx. 400 bar, whereas the second pump provides correspondingly lower values in the range from 6 ml/min to 300 ml/min, particularly preferably in the range from 15 ml/min to 150 ml/min and especially preferably 20 ml/min to 75 ml/min, at a pressure of approx. 400 bar. The values can preferably be measured to DIN EN ISO 17769 (2012).

The system for pumping a compressible fluid is preferably connected to at least one reservoir of a compressible fluid. Each pump can in this case be connected to a corresponding storage vessel. The system according to the invention preferably has a reservoir for feeding a fluid, wherein the first pump and the second pump are in each case fed from an identical reservoir.

It can furthermore be provided that the system has at least one, preferably exactly one, reservoir for feeding a fluid and a cooling unit for cooling the fluid is provided between the feed reservoir and an inlet line for the first pump and/or the second pump. This embodiment can ensure that no or only slight gas formation occurs, wherein this point is of relevance in particular in the event of a relatively low pressure in the reservoir, in the case of CO₂ of 70 bar or below, in particular of 60 bar or below.

The pump outlet lines of the first and the second pump are brought together in a connection piece and guided out from said connection piece into a common outlet line. The total flow rate is accordingly formed by the sum of the flow rates of the first and the second pump, such that the at least two pumps are connected in parallel.

The second pump is controllable by means of a control unit, wherein the control unit is operatively connected to a flowmeter and the pump output of the second pump is controllable as a function of the flow measurement by means of the control unit.

The control unit controls the pump output of the second pump, in particular the flow rate of this pump. The flow rate of the second pump is in turn adjusted as a function of the flow measurement, such that the flow rate (actual flow rate) measured by the flowmeter substantially corresponds to a predetermined flow rate. The predetermined flow rate is in this case the flow rate at which the first pump is to be operated (nominal flow rate), although a reduction in volume which is dependent on temperature and pressure can occur due to the compression. A reduction in volume arising due to compression is accordingly equalized by the second pump. Two flowmeters can be used, the measured values from which are summed. These can independently measure the flow rates of the first and the second pumps. The flowmeter can furthermore be arranged such that only the flow of the first pump is determined and the second pump is controlled accordingly. These two options are, however, associated with relatively high costs or are error-prone. The flowmeter is accordingly preferably arranged in the common outlet line, such that the flow rate measured by the flowmeter corresponds to the total flow rate.

The nature of the flowmeter is in itself non-critical, wherein a person skilled in the art will select it in line with the requirements. The requirements profile comprises inter alia measuring accuracy, pressure resistance, temperature suitability and the intended volumetric or mass flow rate etc. It is accordingly in particular possible to use measuring instruments which measure the mass flow rate, such as for example Coriolis flowmeters, or measuring instruments which measure the volumetric flow rate, such as turbine flowmeters. It can surprisingly therefore be provided that turbine flowmeters are used as the flowmeter. Unexpected cost benefits are achievable in this manner, since a turbine flowmeter is of a substantially simpler design than a Coriolis flowmeter. Suitable turbine flowmeters are for example obtainable from KEM Küppers Elektromechanik GmbH, such as for example devices from the HM R series.

It can furthermore be provided that, viewed in the direction of flow, a heat exchanger is provided in the common outlet line downstream of the connection piece and upstream of the flowmeter. Heat exchangers serve for heat transfer and are known in the art, to which reference can be made.

It can preferably be provided that, viewed in the direction of flow, a pulsation damper is provided in the common outlet line downstream of the connection piece and upstream of the flowmeter. The nature of the pulsation damper is in itself non-critical, wherein a relatively large vessel holding the compressible fluid, preferably CO₂, can preferably serve as the pulsation damper. This vessel preferably has a volume in the range from 50 to 500 ml, preferably in the range from 100 to 350 ml and especially preferably in the range from 140 to 250 ml and can be selected as a function of the intended flow rate.

A further configuration can provide that, viewed in the direction of flow, a non-return valve is provided in the first pump outlet line between the outlet of the first pump and the connection piece. This configuration inter alia facilitates the determination of the nominal flow rate. It can to this end preferably be provided that, viewed in the direction of flow, a pressure measurement sensor is provided in the first pump outlet line between the outlet of the first pump and the connection piece, wherein the pressure measurement sensor is operatively connected to the control unit.

A preferred configuration can provide that, viewed in the direction of flow, a non-return valve is provided in the first pump outlet line between the outlet of the first pump and the connection piece and, viewed in the direction of flow, the pressure measurement sensor is arranged upstream of the non-return valve.

Thanks to the embodiments set out above, which in each case comprise a pressure measurement sensor which is arranged between the outlet of the first pump and the connection piece, it is possible to determine on the basis of the pressure fluctuations the number of strokes performed for example by a piston pump within a unit time. On the basis of the known swept volume and the frequency of the pump strokes of the first pump, it is possible to determine the flow rate at which the first pump is being driven (nominal flow rate).

The system for pumping a compressible fluid can preferably be used in chromatography systems which are designed for supercritical fluid chromatography. The present invention accordingly further provides a chromatography system comprising a system for pumping a compressible fluid according to the present invention.

A chromatography system according to the invention preferably has at least two fluid feed lines via which the at least two fluids are introducible.

It can furthermore be provided that, in addition to the system for pumping a compressible fluid according to the present invention, the chromatography system comprises a third pump which is connected to a fluid reservoir for a second fluid.

Such a system is for example operated using supercritical CO₂ together with a solvent, for example methanol. Accordingly, a chromatography system designed for supercritical liquid chromatography has at least one storage vessel for the solvent and one storage vessel for the supercritical fluid, for example CO₂. In general, the fluid is withdrawn from the storage and transferred with at least one pump respectively into a mixing element that is in fluid communication with a chromatography column. The pumps and/or the mixing element as well as the chromatography column can be provided with a temperature control in order to be able to set a respective predetermined temperature. For this purpose, heat exchangers in particular can be provided. The addition of mixtures to be separated, in particular substances to be purified, can be done by known devices, for example injectors that are preferably provided in the line in which the solvent is fed to the mixing element.

The fluid leaving the chromatography column is preferably at least in part introduced into a detection or analysis unit. Examples of a detection or analysis unit include UV detectors and/or mass spectrometers.

Preferably, it can be provided that the chromatography system comprises an injection device with which samples can be injected automatically into the chromatography system.

The fluid leaving the chromatography column is preferably at least in part introduced into a detection or analysis unit. Preferably, it can be provided that the chromatography system comprises a UV detector. Furthermore, it can be provided that the chromatography system comprises a mass spectrometer as the detector. In a particularly preferred embodiment, the system comprises a UV detector and a mass spectrometer. In this case, further detection methods can also be used that measure, for example, light scattering, fluorescence or the refractive index. Furthermore, mass spectrometers and/or conductivity detectors etc. are frequently used.

Downstream of the chromatography column and preferably downstream of the detection or analysis unit, a backpressure regulator is generally provided, and preferably a heat exchanger is provided downstream of the backpressure regulator. The aerosol leaving the heat exchanger is preferably subsequently fed to a gas-liquid separator.

Preferable gas-liquid separators are known from the prior art, for example from the publication WO 2014/012962 A1, the disclosure of this publication being completely incorporated by reference into the present application for disclosure purposes.

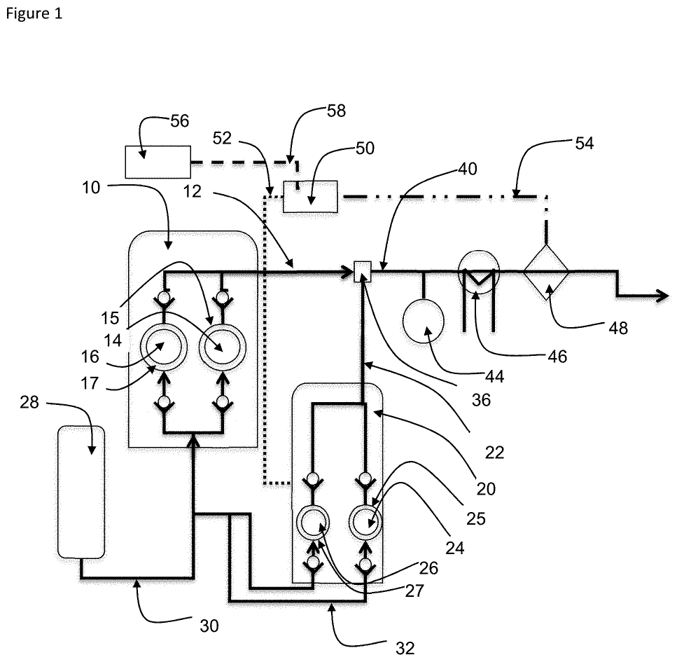

A further preferable gas-liquid separator is described in PCT application with the application number PCT/EP2018/062537 and a filing date of 15 May 2018, the disclosure of this document, in particular the gas-liquid separator and the preferred embodiments of the gas-liquid separator shown therein, being completely incorporated by reference into the present application for disclosure purposes. In particular, the embodiments of the gas-liquid separator shown in FIGS. 1 to 9, are incorporated by reference to the PCT application with the application number PCT/EP2018/062537 into the present application for disclosure purposes.

An unexpected improvement of a baffle separation can be achieved by disposition and configuration of a separation opening. This way, the gas volume provided due to the baffle separation in particular can be reduced, such that the total volume of the gas-liquid separator can be reduced. Surprisingly, the segregation performance of the chromatography system can improved this way.

A preferred gas-liquid separator comprises a separation zone with an inlet nozzle, a baffle unit and a gas-guiding unit.

Preferably, the separation zone is configured in such a way that a baffle separation is effected. Baffle separation means that the liquid droplets in the aerosol are directed against a baffle unit, and as a result thereof, the liquid droplets can form a liquid film.

The baffle unit can be any body against which the aerosol flow can be directed. For example, the aerosol stream can be directed against an upper zone of the separation zone, for example against an upper end of the separation zone. Here, a projection, for example a spike or the like, can be provided, onto which the aerosol stream impinges, such that the liquid droplets directed onto the baffle unit are not thrown back or rebound from the baffle unit, but instead form a film.

A preferred gas-liquid separator uses gravitation during operation, which effects a segregation of gas and liquid. Accordingly, the expression above refers to the orientation of the gas-liquid separator that prevails in operation, such that a gas can flow out upwards while the contrary direction in which a liquid exits the gas-liquid separator is at the bottom thereof.

Besides a baffle unit, an inlet nozzle is preferably provided in the separation zone of the gas-liquid separator. Through the inlet nozzle, the aerosol is introduced into the gas-liquid separator, in particular into the separation zone of the gas-liquid separator.

In this case, the inlet nozzle is preferably formed in such a way that a gas-liquid flow directed through the inlet nozzle is able to impinge against the baffle unit, as has already been explained with regard to the baffle unit.

The shape and type of the inlet nozzle are not critical, such that a person skilled in the art can choose them within the scope of their abilities. Thus, the inlet nozzle can be formed such that the aerosol is directed onto the baffle unit in the form of a very narrow jet. Furthermore, the inlet nozzle can also be constructed in such a way that a conical spray mist is directed onto the baffle unit.

Here, the nozzle can end flush with the wall of the separation zone or a projection can protrude into the separation zone. The embodiment with a projection is advantageous if the baffle unit is provided in the upper end of the separation zone.

Particularly preferably, the inlet nozzle is designed in the form of a simple bore or a simple opening. A further development can provide that the inlet nozzle provided in the separation zone has an entry surface that is essentially circular.

In the separation zone, one or more inlet nozzles can be provided. In the case that several inlet nozzles are provided, they are preferably aligned in parallel. Preferably, the gas-aerosol mixture is introduced into the separation zone by means of exactly one inlet nozzle, preferably onto the baffle unit located in the separation zone.

It can be further provided that the inlet nozzle is formed such that a gas-liquid flow directed through the inlet is able to impinge against the baffle unit and the angle at which a gas-liquid flow directed through the inlet nozzle is able to impinge onto the baffle unit lies preferably in the range from 50 to 130°, particularly preferably in the range from 70 to 110°. This angle can in particular be determined by the direction of the inlet nozzle with which the inlet nozzle is directed to the baffle unit. This information relates to the angle at which the main jet of the aerosol is directed onto the baffle unit. The shape of the aerosol jet in itself is insignificant insofar as baffle separation can be effected. Here, the liquid droplets of the aerosol should flow together as a result of impinging onto the baffle unit and preferably form a film. Therefore, the inlet nozzle should be chosen such that the liquid droplets of the aerosol do not become too small.

The gas-liquid separator preferably has a separation opening that is disposed between the separation zone and the segregation zone, such that there is a gas- and liquid-open connection between these zones. The separation opening preferably effects an inertial separation. This means that liquid flowing downwards on the baffle unit and/or the gas-guiding unit in the form of a liquid film will separate from the gas by inertia. Here, the gas preferably accelerates the liquid such that the liquid is transferred into the segregation zone at a higher speed than without this gas acceleration. Here, the liquid film preferably remains on a wall of the separation zone, which is preferably formed as part of the baffle unit and/or the gas-guiding unit, in the form of a film and passes directly into the segregation zone without the liquid film leaving this wall that continues into the segregation zone. In contrast to the liquid phase, the gas phase does not adhere to a wall, but is able to exit upwards and pass into the gas discharge zone. In contrast to this, the liquid is drained into the segregation zone and withdrawn from the gas-liquid separator through the liquid outlet provided in the segregation zone.

The shape of the separation opening is not critical insofar as the previously described function of the same can be fulfilled. Preferably, however, it can be provided that the separation opening has an outlet surface that is slit-shaped or has a plurality of openings arranged in parallel that can be U-shaped, V-shaped or circular, for example.

Preferably, the distance of the inlet nozzle from the baffle unit is greater than the smallest length dimension of the separation opening. Here, the distance of the inlet nozzle from the baffle unit results from the path of the aerosol from leaving the inlet nozzle until it impinges onto the baffle unit. The smallest length extension of the separation opening relates to the width or length of the separation opening, wherein the extension of the plane up to the edge of the separation opening is related to the plane between the separation zone and the segregation zone that leads to a minimal area of the separation opening. In this plane, in which the separation opening lies, the length of the longest extension of the separation opening is determined, such that the shortest length of the separation opening that is perpendicular to the longest extension of the separation opening can then be measured. This smallest length extension can also be regarded as the width of the separation opening here.

The spatial shape of the separation zone is not critical and can be adapted as needed. Here, a gas-guiding unit is preferably formed in the separation zone. The gas-guiding unit causes a change in the flow velocity of a gas, such that a lower gas velocity prevails in the zone of the inlet nozzle than in the zone of the separation opening. Since the volumetric flow rate can be regarded as constant for the same aerosol composition, this means that the aerosol is first led into a relatively large space that is subsequently constricted, such that the flow velocity increases.

Accordingly, the cross-sectional area of the separation zone, for example, can be circular, wherein, for example, this is preferably constricted in wedge-shaped manner from the inlet nozzle towards the separation opening.

In a preferred embodiment, the separation zone does not have a circular cross-sectional area in the zone of the inlet nozzle, wherein the separation zone preferably comprises at least three sidewalls which, together with an upper end, define a space that is connected to the segregation zone via the separation opening. This embodiment, in which the separation zone does not comprise a circular cross-sectional area, but a cross-sectional area with corners, in particular a triangular, quadrangular, pentagonal or hexagonal cross-sectional area, particularly preferably a quadrangular one, is easier to produce with a required precision, wherein the volume of the gas-liquid separator can be better adapted to the requirements. In particular, gas-liquid separators can also be provided that are suitable for particularly small volumetric flow rates. In contrast to gas-liquid separators with a circular cross-sectional area, gas-liquid separators with a non-circular cross-sectional area, preferably a cross-sectional area with corners, can have exactly one inlet nozzle without zones of inadequate wetting with gas-liquid mixture occurring.

Preferably, it can be provided that the gas-guiding unit has at least two essentially flat sidewalls that can be regarded as gas-guiding plates, wherein these gas-guiding plates preferably form walls of the separation zone. These two essentially flat sidewalls can converge towards one another such that a wedge shape is formed.

Further, it can be provided that the gas-guiding unit has at least two sidewalls, wherein at least one of the sidewalls is curved, such that a concave shape is provided such that the two sidewalls can converge, wherein in the upper zone of the separation zone that is defined by the proximity of the inlet nozzle, the distance between the sidewalls is greater than in the lower zone of the separation zone that is defined by the proximity of the separation opening, wherein the decrease in the distance decreases in the direction from the upper zone to the lower zone.

A further configuration can provide that the cross-sectional area of the gas-guiding unit decreases from the inlet nozzle in the direction of the separation opening at least in zones, preferably in the zone facing the separation opening, such that the planes that are perpendicular to the direction of flow of the gas-liquid mixture become smaller, wherein this decrease is preferably continuous, such that preferably at least two of the sidewalls of the gas-guiding unit form a wedge shape in longitudinal section.

A further configuration can provide that the separation zone comprises an upper end, wherein this upper end comprises a curvature or an angle, the highest point of the curvature or the angle preferably being disposed in the center, and thus aligned with the inlet nozzle on a line that notionally extends parallel to the direction of the outlet opening, wherein the upper end preferably merges into two sidewalls, such that the transition between the sidewalls and the upper end is curved.

Further, it can be provided that the inlet nozzle is provided in the upper zone of the separation zone, particularly preferably in the upper third of the separation zone, wherein this direction results from the disposition of the inlet and the liquid outlet, such that the inlet nozzle is disposed above the liquid outlet.

Besides the separation zone described above, a gas-liquid separator according to the invention has a segregation zone. In the segregation zone, as already indicated, the phases are segregated, wherein the segregation zone has a liquid outlet through which the liquid phase is removable from the gas-liquid separator. The gas phase is led into the gas discharge zone. Accordingly, the segregation zone is connected to the gas discharge zone by means of an opening and is in fluid communication with the same.

Preferably, it can be provided that the segregation zone with a liquid outlet comprises a bottom that preferably comprises a curvature, a bend, an angle or another shape that leads to a taper, wherein the liquid outlet is provided in the zone of the lowest point of the bottom.

Further, it can be provided that the liquid outlet is provided in the lower zone of the segregation zone, particularly preferably in the lower third of the segregation zone, wherein this direction results from the disposition of the inlet nozzle and of the liquid outlet, such that the inlet nozzle is disposed above the liquid outlet.

The gas discharge zone serves to discharge the gas phase from the gas-liquid separator, such that it comprises a gas outlet.

Preferably, the gas discharge zone is configured such that the gas speed at the gas outlet is at a maximum, preferably the gas speed increases in the gas flow direction from the segregation zone in the direction of the gas outlet. This way, a suction effect can be brought about that leads to safe and low-maintenance operation of the gas-liquid separator. In this way, the volume of the gas-liquid separator can be further reduced without the performance of other properties, for example the segregation properties, decreasing.

In reverse of the separation zone, the space therefore decreases from the direction of the segregation zone towards the gas outlet. Preferably, the cross-sectional area tapers from the direction of the segregation zone towards the gas outlet.

Depending on the type of gas, the gas phase of the aerosol can be collected and processed or, for example, when CO₂ is used, also released into the environment.

The liquid phase of the aerosol is preferably collected in a fraction collector. It is particularly preferred that the collected fractions be automatically collected as main fractions, while excess solvent can be subjected to processing or disposal. The connecting line between the liquid outlet of the gas-liquid separator and the fraction collector can preferably be formed such that residues of the gas phase, preferably CO₂ residues, can escape via this connection. A semipermeable plastic material, for example Teflon, particularly preferably AF 2400 (commercially available from DuPont) can be used for this purpose.

In a preferred configuration, it can be provided that the chromatography system is controllable by means of a chromatography system controller and the chromatography system controller is operatively connected to or forms a unit with the control unit of the system for pumping a compressible fluid according to the present invention.

It can further be provided that the chromatography system comprises a chromatography system controller that is operatively connected to a detector and a fraction collector and the controller is programmable such that the quantity of fluid introducible into a vessel of the fraction collector is determinable as a function of the proportion of the first solvent.

It can further be provided that the chromatography system comprises a chromatography system controller which is operatively connected to the first pump, wherein the pump output of the first pump is controllable by means of the chromatography system controller.

Moreover, it can be provided that, in addition to the system for pumping a compressible fluid according to the present invention, the chromatography system comprises a third pump which is connected to a second fluid reservoir, wherein the pump output of the third pump is controllable by means of the chromatography system controller.

The chromatography system is preferably formed as an SFC system, wherein a chromatographic procedure with a solvent gradient is performable.

The SFC chromatography system is preferably operable at a volumetric flow rate in the range from 10 ml/min to 450 ml/min, particularly preferably in the range from 50 ml/min to 300 ml/min and especially preferably 100 ml/min to 250 ml/min. It can furthermore be provided that the SFC chromatography system is preferably operable at a volumetric flow rate of at least 10 ml/min, particularly preferably of at least 50 ml/min and especially preferably of at least 100 ml/min.

According to another aspect, a conversion kit is also provided, by means of which a high-performance liquid chromatography system (HPLC) can be converted into an SFC system. Such a kit comprises at least one system for pumping a compressible fluid as described above. The kit preferably contains further components, as described previously and below, in order to convert an HPLC system into an SFC system, for example, gas-liquid separators, heat exchangers or backpressure regulators.

Different components are required depending on the specific configuration of the system to be converted. In the most favorable case, one of the pumps of the HPLC system is suitable for operation with a compressible fluid, in particular with liquid or supercritical 002, such that the only requirement is a second pump which is controlled in accordance with the present explanations. In the event of conversion, the information about the flow rate of the first pump can, for example, be provided, depending on the system, by the chromatography system controller. If no appropriate interface is available, the flow rate at which the first pump is to be operated (nominal flow rate) can be determined by the frequency at which the pump operates, wherein the nominal flow rate can be established on the basis of the first pump's known swept volume. Frequency is preferably determined by detecting pressure variations during pump operation (pulsation).

The present invention also provides a method for performing a chromatographic procedure, in which a system according to the invention for pumping a compressible fluid or a chromatography system with a system according to the invention for pumping a compressible fluid is used. A solvent gradient is preferably used for performing a chromatographic procedure.

The gas used for performing a chromatographic procedure is preferably one which can relatively easily be brought into a supercritical state. Preferred gases which have these properties include, inter alia, carbon dioxide (CO₂), ammonia (NH₃), Freon or xenon, wherein carbon dioxide (CO₂) is particularly preferred.

It can further be provided that an inorganic or organic solvent which is liquid under the usual segregation conditions, in particular at 25° C. and atmospheric pressure (1023 mbar), is used in a chromatography method according to the invention. In this case, a polar or non-polar solvent can be used, depending on the type of compounds to be separated or purified.

Preferably, it can be provided that the gas-liquid mixture to be brought into the supercritical state comprises a polar solvent and a gas that is selected from the group consisting of CO₂, NH₃, Freon, xenon, preferably CO₂. Preferably, the polar solvent is an alcohol, preferably methanol, ethanol or propanol, hexane, mixtures with dichloromethane, chloroform, water (preferably up to a maximum of 3% by volume, since otherwise a miscibility gap can occur), an aldehyde or a ketone, preferably methyl ethyl ketone; an ester, preferably ethyl acetate; or an ether, preferably tetrahydrofuran.

Further, it can be provided that the gas-liquid mixture to be brought into the supercritical state comprises a non-polar solvent and a gas that is selected from the group consisting of CO₂, NH₃, freon, xenon, preferably CO₂. Preferably, the non-polar solvent is an aliphatic hydrocarbon, preferably hexane, cyclohexane, heptane, octane; an aromatic hydrocarbon, preferably benzene, toluene, xylene; an ester, preferably ethyl acetate; or an ether, preferably tetrahydrofuran.

It can further be provided that the chromatographic procedure is performed using a first solvent which is liquid under standard conditions and a second solvent which is gaseous under standard conditions, and the two solvents are mixed prior to introduction into a chromatography column, wherein the solvent composition pumped into the chromatography column is modified over the course of the chromatographic procedure.

In a preferred embodiment of the method, in which the chromatography system comprises a backpressure regulator, by means of which the pressure in the gas-liquid separator is closed-loop controllable, it can be provided that the pressure is closed-loop controlled as a function of the solvent content of the gas-liquid mixture, said control preferably being configured such that a high pressure is provided in the gas-liquid separator when the solvent content is high.

In the following, preferred embodiments of the present invention shall be described by way of example with reference to four figures, without any restriction of the invention being intended. Therein:

FIG. 1 is a representation of a first embodiment of a system according to the invention for pumping a compressible fluid,

FIG. 2 is a representation of a second embodiment of a system according to the invention for pumping a compressible fluid,

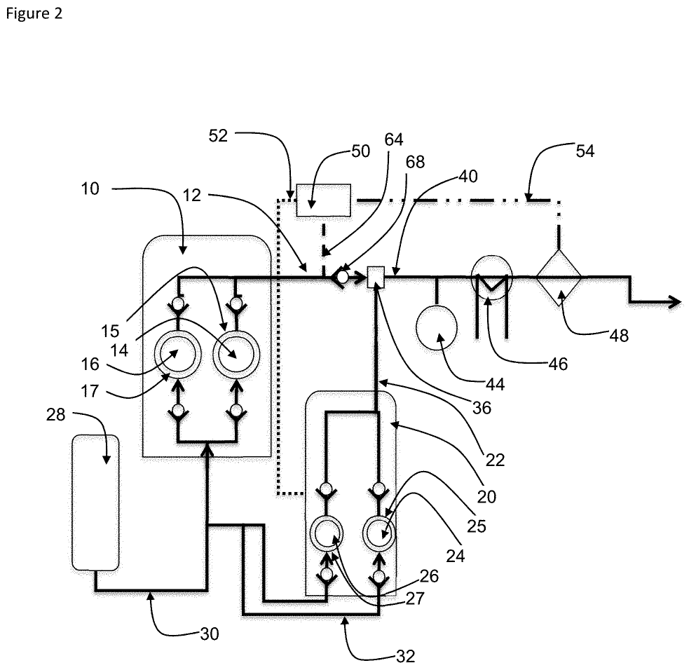

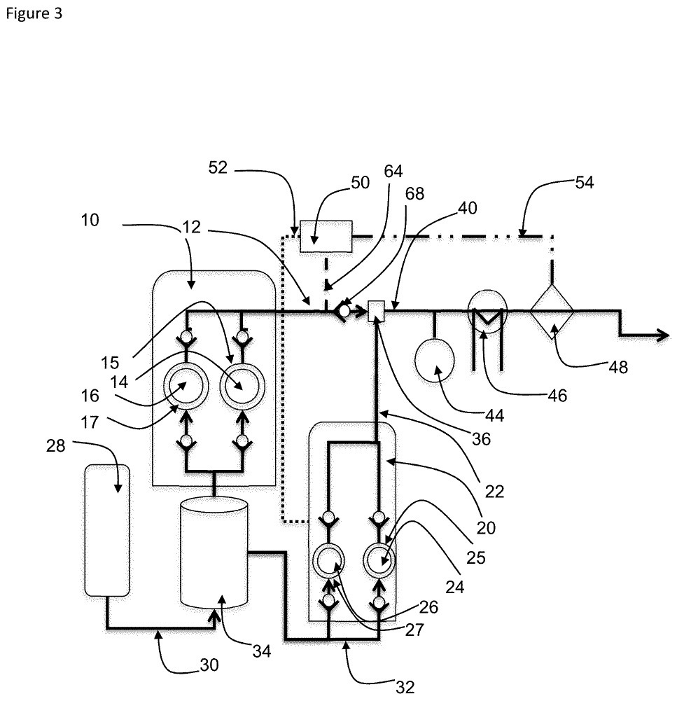

FIG. 3 is a representation of a third embodiment of a system according to the invention for pumping a compressible fluid,

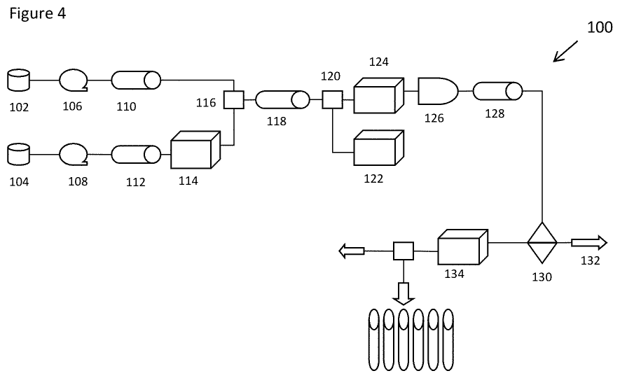

FIG. 4 is a schematic representation of a chromatography system with a system according to the invention for pumping a compressible fluid.

FIG. 1 describes a first embodiment of a system according to the invention for pumping a compressible fluid.

The system comprises two pumps, a first pump (10) and a second pump (20), the respective pump outlet lines (12, 22) of which are brought together in a connection piece (36) and guided out from said connection piece (36) into a common outlet line (40).

In the present embodiment, the pumps are connected to a reservoir (28), wherein the fluid line (30) via which a fluid is guided into the first pump (10) comprises a branch, such that the second pump (20) is correspondingly supplied with fluid via the fluid line (32).

The first pump (10) has two pistons (14, 16), the pump head of which in each case has cooling (15, 17). The second pump (20) likewise comprises two pistons (24, 26) which are in each case equipped with pump head cooling (25, 27). Pump head cooling is in particular expedient for maintaining the fluid in a liquid state since gas formation can be effectively prevented in this manner.

The fluid is guided into the outlet line (40) via the connection piece (36) which brings together the respective pump outlet lines (12, 22). The outlet line (40) in the present embodiment firstly comprises a pulsation damper (44) which can for example take the form of a relatively large vessel into and out of which the fluid is guided. In the present case are then arranged, viewed in the direction of flow, a heat exchanger (46) and a flowmeter (48).

The flowmeter (48) is connected to a control unit (50), by means of which the second pump (20) is controllable. In the present embodiment, the control unit (50) is connected via the control line (52) to the second pump (20) and via the measurement line (54) to the flowmeter (48).

The pump output of the second pump (20) is controllable by means of the control unit (50) as a function of flow measurement. In the control unit (50), a nominal flow rate is here preferably compared with an actual value thereof and the pump output of the second pump (20) correspondingly adapted to equalize the two values. Due to the compressibility of the fluid, for example of the liquid or supercritical carbon dioxide (CO₂), the actual value is conventionally always lower than the nominal value, such that the pump output of the second pump (20) is always greater than or equal to zero.

In the present embodiment, the nominal value of the first pump (10) can be determined by means of the chromatography system controller (56), wherein a data line (58) provides a connection between the chromatography system controller (56) and the control unit (50), via which the control unit (50) receives the corresponding values. It is, however, obvious to a person skilled in the art that the chromatography system controller (56) and the control unit (50) can be designed as one item of equipment. The first pump (10) can be controlled by means of the chromatography system controller (56), wherein the corresponding connection is not shown for reasons of clarity.

In the present embodiment, the devices shown are in particular suitable for converting an existing HPLC system, wherein the control unit (50) is separate from the chromatography system controller (56). The second pump (20) is controlled in such a manner that any shortfall in the volume of fluid caused by compression of the compressible fluid and identified by the comparison between the nominal flow rate and actual flow rate is made up by means of the pump output from the second pump (20).

FIG. 2 shows a second embodiment of a system according to the invention for pumping a compressible fluid.

This embodiment likewise comprises two pumps, a first pump (10) and a second pump (20), wherein the respective pump outlet lines (12, 22) of which are brought together in a connection piece (36) and guided out from said connection piece (36) into a common outlet line (40). In the outlet line (40) is provided a flowmeter (48) which is connected to a control unit (50) by means of which the second pump (20) is controllable. In the present embodiment, the control unit (50) is connected via the control line (52) to the second pump (20) and via the measurement line (54) to the flowmeter (48).

The device shown in FIG. 2 thus corresponds in many details to the system shown in FIG. 1, wherein identical reference signs denote identical components, such that the explanations provided in respect of FIG. 1 also apply to the second embodiment.

The embodiment described in FIG. 2 in particular differs in that the nominal values of the flow rate of the first pump (10) are not provided by the chromatography system controller (56).

This nominal output therefore has to be determined by other methods. The corresponding flow rate of the first pump (10) is determined in the present embodiment on the basis of the frequency of the first pump (10). A pressure sensor, which is connected via measurement line (64) to control unit (50), is provided to this end in the outlet line (12) of the first pump (10). Pump frequency can be determined by measuring the pressure variations which accompany the piston stroke of a piston pump. Multiplying the pump frequency by the known swept volume provides the flow rate of the first pump (10) as a nominal value. A non-return valve (68) is provided in the outlet line (12) of the first pump (10) between the sensor, connected via the measurement line (64) to the control unit (50), and the connection piece (36) in order to improve measuring accuracy.

FIG. 3 shows a third embodiment of a system according to the invention for pumping a compressible fluid.

This embodiment likewise comprises two pumps, a first pump (10) and a second pump (20), wherein the respective pump outlet lines (12, 22) of which are brought together in a connection piece (36) and guided out from said connection piece (36) into a common outlet line (40). In the outlet line (40) is provided a flowmeter (48) which is connected to a control unit (50) by means of which the second pump (20) is controllable. In the present embodiment, the control unit (50) is connected via the control line (52) to the second pump (20) and via the measurement line (54) to the flowmeter (48).

The device shown in FIG. 3 therefore corresponds in many details to the systems shown in FIGS. 1 and 2, wherein identical reference signs denote identical components, such that the explanations provided in respect of FIGS. 1 and 2 also apply to the third embodiment.

The embodiment described in FIG. 3 in particular differs from the configuration described in FIG. 2 in that the system has a cooled fluid feed line. Cooling for the fluid (34) is accordingly provided between the reservoir (24) and the inlet lines to the first pump (10) and the second pump (20).

This configuration is in particular expedient for reservoirs in which the fluid is stored and supplied to the pumps under relatively low pressure. In the case of CO₂, gas formation can occur if the reservoir has a pressure of 60 bar or below, such that corresponding cooling is expedient in order to keep the fluid in the liquid or supercritical state on supply to the pumps. Details with regard to the corresponding temperature or pressure are obtainable from the fluid's boiling point diagram.

FIG. 4 is a schematic representation of a chromatography system 100 with a system according to the invention for pumping a compressible fluid.

Such a system is described by way of example using supercritical CO₂, wherein methanol is shown as an exemplary solvent. Obviously, systems in which other solvents, preferably organic solvents are applied, or other supercritical fluids are used, have a similar structure.

As shown in FIG. 4, the respective fluids are stored in reservoirs (102, 104) and supplied to the system with a system according to the invention for pumping a compressible fluid (106) or a pump (108). In particular, the gas subsequently used in a supercritical state is stored in a storage tank (102) and supplied to the further components of the system by means of a system according to the invention for pumping a compressible fluid (106). The solvent is provided in a storage tank (104) which is delivered by means of a pump (108) to the further components of the system. In the system 100 described here, a preparation stage (110, 112) is preferably provided in each fluid feed line, by means of which the fluids can be temperature controlled. Further, a leveling of the pressure fluctuations indicated by the pumps can also be provided. Accordingly, this preparation stage can be designed, for example, as a heat exchanger or as a pump. Depending on the configuration of system for pumping a compressible fluid (106), component (110) can be part of the system according to the invention (106). In the solvent line, an addition unit (114) can preferably be provided, for example an injector, by means of which a mixture to be segregated is introduced into the system (100) before the CO₂ and the solvent are passed into a mixer (116) and from the latter to a chromatography column (118).

In the present system (100), two analysis units are arranged downstream of the chromatography column (118), wherein a sample discharge unit (120) is connected to a mass spectrometer (122) and a UV detector (124) is provided downstream of the sample discharge unit. The backpressure regulator (126) provided in the line maintains the particular pressure that is necessary for the fluid to remain in a supercritical state. Downstream of the backpressure regulator (126) is provided a heat exchanger (128) which prevents the aerosol from freezing during the expansion process. Subsequently, the aerosol is introduced into a gas-liquid separator (130) according to the invention, wherein the gas in the system is discharged via an outlet (132).

The liquid is introduced into a fraction collector (134) and fractionated therein. The solvent contained in the fractionated samples can be removed from the samples.

The features of the invention disclosed in the preceding description, as well as in the claims, figures and exemplary embodiments, can be essential both individually and in any combination for realizing the invention in its various embodiments.

Systems which allow the nominal flow rate of the first pump to be established by means of the chromatography system controller may accordingly also include cooling of the fluid between reservoir and pumps. The optional components, for example the pulsation damper or the heat exchanger, can furthermore, if present, also be arranged in different locations.

1. A system for pumping a compressible fluid, comprising at least two pumps including a first pump and a second pump, each pump having a pump outlet line, the respective pump outlet lines of which are brought together in a connection piece and are guided out of the connection piece into a common outlet line, wherein the second pump is controllable by a control unit, wherein the control unit is operatively connected to a flowmeter, and pump output of the second pump is controllable as a function of the flow measurement by the control unit.

2. The system according to claim 1, wherein the flowmeter is arranged in the common outlet line.

3. The system according to claim 1, wherein viewed in a direction of flow, a heat exchanger is provided in the common outlet line downstream of the connection piece and upstream of the flowmeter.

4. The system according to claim 1, wherein, viewed in the direction of flow, a pulsation damper is provided in the common outlet line downstream of the connection piece and upstream of the flowmeter.

5. The system according to claim 1, wherein the first pump and/or the second pump is a piston pump with two pistons.

6. The system according to claim 1, wherein, viewed in the direction of flow, a pressure measurement sensor is provided in the first pump outlet line between an outlet of the first pump and the connection piece, wherein the pressure measurement sensor is operatively connected to the control unit.

7. The system according to claim 1, wherein pump output of the first pump is higher than the pump output of the second pump.

8. A chromatography system comprising a system for pumping a compressible fluid according to claim 1.

9. The chromatography system according to claim 8 wherein, in addition to the system for pumping a compressible, the chromatography system comprises a third pump which is connected to a fluid reservoir for a second fluid.

10. The chromatography system according to claim 8, wherein the chromatography system includes a chromatography column and, downstream, viewed in a direction of flow, at least one backpressure regulator.

11. The chromatography system according to claim 10, wherein, viewed in the direction of flow, a gas-liquid separator is provided downstream of the backpressure regulator.

12. The chromatography system according to claim 8, wherein the chromatography system is controllable by a chromatography system controller and the chromatography system controller is operatively connected to or forms a unit with the control unit of the system for pumping a compressible fluid.

13. The chromatography system according to claim 8, wherein the chromatography system is formed as a supercritical fluid chromatography (SFC) system, wherein a chromatographic procedure with a solvent gradient is performable.

14. A method for performing a chromatographic procedure comprising using a chromatography system according to claim 8.

15. A set for converting a high pressure liquid chromatography (HPLC) system into a chromatography system according to claim 8 comprising at least one system for pumping a compressible fluid according to claim 1 and a gas-liquid separator.

16. The system according to claim 7, wherein the pump output of the first pump is at least twice the pump output of the second pump.
